(19) United States
(12) Patent Application Publication
(10) Pub. No.: US 2026/0022033 A1
(43) Pub. Date: Jan. 22, 2026

(54) WATER PURIFICATION AGENT AND METHOD FOR PRODUCING SAME

(71) Applicant: SHARP KABUSHIKI KAISHA, Sakai city (JP)

(72) Inventor: Yohei OTSUKA, Sakai City (JP)

(21) Appl. No.: 19/243,750

(22) Filed: Jun. 20, 2025

(30) Foreign Application Priority Data
Jul. 17, 2024 (JP) 2024-114232

(51) Int. Cl. C02F 1/28; B01J 20/04; B01J 20/10; B01J 20/20; B01J 20/22; B01J 20/28; B01J 20/30; C02F 101/20

(52) U.S. Cl. CPC C02F 1/288; B01J 20/041; B01J 20/103; B01J 20/20; B01J 20/22; B01J 20/28004; B01J 20/28009; B01J 20/28019; B01J 20/28059; B01J 20/3078; C02F 2101/203

(57) ABSTRACT

The disclosure provides a water purification agent that can be produced from a two-component developer and can elute divalent iron ions into water. The water purification agent of the disclosure is characterized by having a plurality of iron ion-eluting particles, each including a magnetic particle containing iron, a carbon layer adhered to the surface of the magnetic particle, and silica particles adhered to the surface of the magnetic particle or the carbon layer.

### TECHNICAL FIELD

The disclosure relates to a water purification agent and a method for producing the water purification agent.

### BACKGROUND ART

Two-component developers containing a toner and a carrier (magnetic particles) containing iron are used in devices that use an electrophotographic method, such as in copiers, multifunctional devices, printers, and facsimile machines. Moreover, the developer contains silica nanoparticles as an external additive. The carrier contained in the developer is constituted by a core material and a resin layer covering the surface of the core material, has a function of charging and transporting the toner in a developing tank, and is repeatedly used. When the carrier is used for a long period of time, the carrier degrades due to contamination from toner components, detachment and wear of the resin layer, and the like, and thus the carrier must be replaced with a new carrier.

In addition, to improve a water environment, a sintered body that can elute divalent iron ions into the water is known.

### SUMMARY

### Technical Problem

A used two-component developer containing a degraded carrier is treated as industrial waste. Therefore, a method for reusing the used two-component developer is desired.

The disclosure was achieved in view of the above circumstances and provides a water purification agent that can be produced from a two-component developer and can elute divalent iron ions into water, and also provides a method for producing the same.

### Solution to Problem

The disclosure provides a water purification agent containing iron ion-eluting particles, with each iron ion-eluting particle having: a magnetic particle containing iron; a carbon layer adhered to the surface of the magnetic particle; and silica particles adhered to the surface of the magnetic particle or the carbon layer. The disclosure also provides a method for producing the water purification agent, the production method including a step of firing a two-component developer at a temperature of 500° C. or higher.

### Advantageous Effects of Disclosure

A water purification agent of the disclosure can elute divalent iron ions into water and improve the water environment. In addition, the water purification agent of the disclosure contains silica particles, and therefore harmful heavy metal ions can be adsorbed on the silica particles, and the water environment can be improved. Moreover, the water purification agent of the disclosure can be produced from a used two-component developer. The water purification agent of the disclosure can also be produced from an unused two-component developer.

### BRIEF DESCRIPTION OF THE DRAWINGS

FIG. 1A is a schematic cross-sectional view of a two-component developer, and

FIG. 1B is a schematic cross-sectional view of an iron ion-eluting particle contained in a water purification agent according to an embodiment of the disclosure.

FIG. 2 is an explanatory view of water purification by the water purification agent according to an embodiment of the disclosure.

FIG. 3 is a SEM photograph of a prepared sample.

FIGS. 4A to 4D are explanatory diagrams of an experimental method for measuring the concentration of divalent iron ions.

### DESCRIPTION OF EMBODIMENTS

The water purification agent of the disclosure is characterized by having a plurality of iron ion-eluting particles, each including a magnetic particle containing iron, a carbon layer adhered to the surface of the magnetic particle, and silica particles adhered to the surface of the magnetic particle or the carbon layer.

The carbon layer is preferably affixed to the surface of the magnetic particle.

The iron ion-eluting particles are preferably fired bodies.

The average particle size D50 of primary particles of the silica particles is preferably 200 nm or less, and more preferably 100 nm or less. When the primary particle size of the silica is large, the silica may detach from the water purification agent. In addition, when the primary particle size is large, the specific surface area decreases, and the number of silanol groups on the surface is reduced, and as a result, the effect of water purification is decreased.

The average particle size D50 of the iron ion-eluting particles is preferably from 20 μm to 100 μm and more preferably from 30 μm to 60 μm. When the particle size is large, contact points between the metal iron and the carbon are reduced, and conversely, when the particle size is small, the mixability with the carbon material becomes poor due to a reduction in the bulk specific gravity, and voids are generated in the iron ion-eluted body due to the elution of iron, making the iron ion-eluted body more susceptible to collapse.

The plurality of iron ion-eluting particles contained in the water purification agent have a particle size distribution such that (D90−D10)/D50 is preferably from 0.5 to 2.0, and more preferably from 0.8 to 1.5.

The BET specific surface area of the plurality of iron ion-eluting particles contained in the water purification agent is preferably from 0.5 m²/g to 50 m²/g, and more preferably from 5 m²/g to 50 m²/g.

The iron ion-eluting particles preferably contain at least one of manganese, magnesium, and potassium.

The water purification agent of the disclosure preferably further contains ascorbic acid.

The coverage rate of the carbon layer covering the magnetic particle is preferably from 80% to 99%, and more preferably from 85% to 95%. When the coverage rate of the carbon layer covering the magnetic particle is reduced, the exposed portion of the carrier core increases, that is, the contact points with carbon are reduced, and the elution amount decreases.

The circularity of the iron ion-eluting particles is preferably 0.85 or greater, and more preferably 0.90 or greater. When this circularity is low and the water purification agent is inserted into water and deposited, voids are not secured, and the surface area of contact between the water purification agent and the water is reduced, and therefore the elution amount of iron ions is reduced.

The proportion of the carbon layer in each iron ion-eluting particle is preferably from 1.0 wt. % to 10 wt. %. When this proportion of the carbon layer is small, the contact points between iron and carbon are reduced, and the elution amount of iron ions is reduced.

An embodiment of the disclosure will be described below with reference to the drawings. Configurations illustrated in the drawings and presented in the following description are examples, and the scope of the disclosure is not limited to the configurations illustrated in the drawings or presented in the following description.

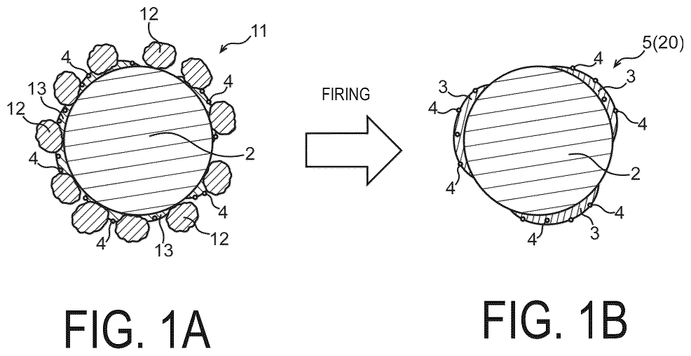

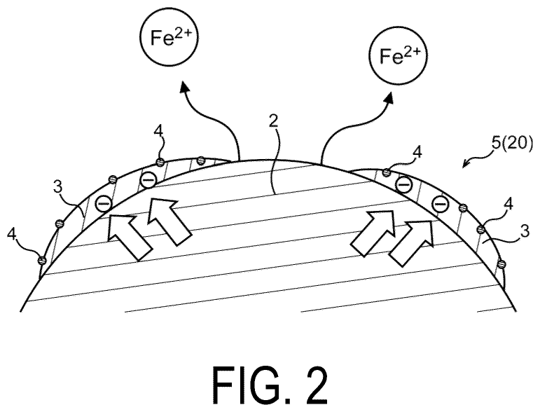

FIG. 1A is a schematic cross-sectional view of a two-component developer, and FIG. 1B is a schematic cross-sectional view of an iron ion-eluting particle contained in a water purification agent of the present embodiment. FIG. 2 is an explanatory view of water purification by the water purification agent of the present embodiment.

A water purification agent 20 of the present embodiment is characterized by having a plurality of iron ion-eluting particles 5, each of the iron ion-eluting particles 5 including a magnetic particle 2 containing iron, a carbon layer 3 adhered to the surface of the magnetic particle 2, and silica particles 4 adhered to the surface of the magnetic particle 2 or the carbon layer 3.

The method for producing the water purification agent 20 of the present embodiment includes a step of firing a two-component developer 11 at a temperature of 500° C. or higher. Moreover, the water purification agent 20 of the present embodiment is not required to be fired.

The water purification agent 20 is a purification agent for improving water quality in seas, rivers, lakes, ponds, canals, ditches, water tanks, and the like. More specifically, the water purification agent 20 is a purification agent that improves water quality by eluting divalent iron ions into the water.

The water purification agent 20 has a plurality of iron ion-eluting particles 5. The iron ion-eluting particles 5 are particles that can elute iron ions into water. The iron ion-eluting particle 5 has a magnetic particle 2 containing iron, a carbon layer 3 adhered to the surface of the magnetic particle 2, and silica particles 4 adhered to the surface of the magnetic particle 2 or the carbon layer 3. The water purification agent 20 (iron ion-eluting particles 5) may be in the form of a powder.

The electronegativity of iron is 1.8 and the electronegativity of carbon is 2.5.

Therefore, for example, as illustrated in FIG. 2, when the water purification agent 20 is immersed in water, electrons in the magnetic particle 2 move to the carbon layer 3, and iron contained in the magnetic particle 2 is eluted into the water as divalent iron ions. The eluted divalent iron ions are absorbed by algae 16 and phytoplankton and are thought to improve the water quality by activating the algae 16 and phytoplankton. It is also considered that the eluted divalent iron ions react with hydrogen sulfide (a malodorous substance generated from sludge or the like) to form iron (II) sulfide (FeS), which then precipitates. Therefore, toxic hydrogen sulfide can be removed, and the water environment can be converted to a water environment in which organisms can easily live.

It is also considered that the divalent iron ions eluted from the magnetic particles 2 react with phosphoric acid (eutrophication: detergents, agricultural chemicals, fertilizers, etc.) to form iron (III) phosphate (FePO₄), which then precipitates. Therefore, eutrophication, which causes algae bloom and red tide, can be prevented, and the water can be purified to achieve an improved water quality. Further, photosynthesis is activated by the absorption of precipitated iron content by the algae 16, and thereby the water quality can be improved.

The water purification agent 20 may contain ascorbic acid. The formation of trivalent iron ions resulting from the oxidation of the divalent iron ions eluted into the water from the water purification agent 20 can be suppressed by containing ascorbic acid. Trivalent iron ions are less likely to be absorbed by the algae 16, phytoplankton, and the like than divalent iron ions. The water purification agent 20 can contain ascorbic acid at an amount of from 0.01 wt. % to 8 wt. % in relation to the iron ion-eluting particles 5.

The average particle size D50 of the iron ion-eluting particles 5 is, for example, from 20 μm to 100 μm. Through this feature, the amount of divalent iron ions eluted from the water purification agent 20 into the water can be increased. The particle size distribution of the plurality of iron ion-eluting particles 5 contained in the water purification agent 20 is preferably a distribution in which (D90−D10)/D50 is from 0.5 to 2.0. Through this feature, the sizes of the iron ion-eluting particles 5 can be made uniform, and a stable amount of divalent iron ions can be eluted from the water purification agent 20 into water.

The BET specific surface area of the plurality of iron ion-eluting particles 5 contained in the water purification agent 20 is preferably from 0.5 m²/g to 50 m²/g. Through this feature, the amount of divalent iron ions eluted from the water purification agent 20 into the water can be increased.

The average circularity of the plurality of iron ion-eluting particles 5 contained in the water purification agent 20 is preferably 0.85 or greater. The average circularity can be calculated by, for example, averaging the circularity of 50 iron ion-eluting particles 5 arbitrarily selected from the iron ion-eluting particles 5 contained in the water purification agent 20.

The iron ion-eluting particles 5 can be produced by firing the two-component developer 11 at a temperature of 500° C. or higher (preferably 600° C. or higher, and more preferably 700° C. or higher). Alternatively, the iron ion-eluting particles 5 may be produced by mixing the two-component developer 11 with a carbon material or an organic component and firing the mixture. The iron ion-eluting particles 5 may also be produced by treating the two-component developer 11 and firing the resulting product.

The firing can be implemented in an atmosphere with a low oxygen gas concentration, such as in a nitrogen gas atmosphere. Through this firing, organic matter contained in the two-component developer 11 can be carbonized, and the carbon layer 3 can thereby be formed.

The two-component developer 11 contains a toner and a carrier. As illustrated in the cross-sectional view of FIG. 1A, the particles contained in each two-component developer 11 can include the magnetic particle 2 as a carrier core, a resin layer 13 covering the surfaces of the magnetic particle 2, toner base particles 12 adhered to the resin layer 13, and silica particles 4 as an external additive. The two-component developer 11 can be produced by mixing the toner and the carrier using a known mixer.

The carrier is composed of the magnetic particle 2 serving as the carrier core and the resin layer 13 covering the surface of the magnetic particle 2. Since the magnetic particle 2 is heat resistant, the description of the magnetic particles 2 is a description of both the magnetic particle 2 contained in the carrier and the magnetic particle 2 contained in the iron ion-eluting particle 5.

Any magnetic particle commonly used in the relevant field can be used as the magnetic particle 2 as long as the magnetic particle contains iron, and examples thereof include magnetic metals such as iron, copper, nickel, and cobalt, and magnetic metal oxides such as ferrite and magnetite. Among these, manganese-magnesium-based ferrite is preferable. The magnetic particle 2 also preferably contains metal iron. The magnetic particle 2 also preferably contains manganese or magnesium. When the magnetic particle 2 contains manganese or magnesium, manganese ions or magnesium ions can be eluted into water together with divalent iron ions from the water purification agent 20 immersed in the water. Manganese and magnesium are essential elements for plants, and through the elution of manganese ions or magnesium ions into water, aquatic plants and phytoplankton are activated, and the ecosystem is enriched. Furthermore, magnesium oxide produced from the eluted magnesium ions improves the pH of sediment and can suppress the generation of hydrogen sulfide gas and odors generated from sludge.

The resin layer 13 becomes the carbon layer 3 upon firing of the two-component developer 11. As the resin layer 13, a substance commonly used in the electrophotographic field can be used, and examples thereof include polytetrafluoroethylene, a mono-chlorotrifluoroethylene polymer, polyvinylidene fluoride, silicone resin, polyester resin, a metal compound of di-tert-butylsalicylic acid, a styrene-based resin, an acrylic-based resin, a polyamide, polyvinyl butyral, nigrosine, an aminoacrylate resin, a basic dye, and a lake product of a basic dye. These resins are carbonized by firing.

The resin layer 13 may contain from 0.3 parts by weight to 5.0 parts by weight of a carbon material, and preferably from 0.5 to 3.0 parts by weight of the carbon material, per 100 parts by weight of the resin. Examples of the carbon material contained in the resin layer 13 include carbon black, acetylene black, activated carbon, graphite, and porous carbon materials, and carbon black is most preferable.

The toner is composed of toner base particles 12 and an external additive. The organic components contained in the toner and external additive are carbonized by firing to form the carbon layer 3.

Each toner base particle 12 contains a binder resin, a colorant, and a release agent, and may further contain, as necessary, a charge control agent, a wax dispersant, a grinding aid, and the like. The glass transition temperature (Tg) of the toner base particles 12 is preferably 60° C. or less.

As the binder resin, a resin commonly used in the relevant technical field can be used. Moreover, a plurality of resins may be used in combination.

As the colorant, a carbon-based coloring material can be used. Examples thereof include carbon black, acetylene black, activated carbon, graphite, and porous carbon materials.

As the release agent, any release agent commonly used in the relevant technical field can be used. A plurality of release agents may also be used in combination.

The melting point of the release agent is preferably from 70° C. to less than 150° C. The blending amount of the release agent in the toner base particles 12 may be appropriately selected according to the intended purpose. For example, the toner base particles 12 preferably contain from 0.5 to 5.0 parts by weight (from 2.0 to 5.0 wt. % in terms of wt. %) of the release agent per 100 parts by weight of the binder resin.

As the charge control agent, a charge control agent commonly used in the relevant technical field can be used. The charge control agent may also include potassium. The blending amount of the charge control agent in the toner base particles 12 may be appropriately selected according to the intended purpose. For example, the toner base particles 12 preferably contain from 0.5 to 3 parts by weight (from 0.5 to 2.0 wt. % in terms of wt. %) of the charge control agent per 100 parts by weight of the binder resin. In a case in which the charge control agent contains potassium, the water purification agent 20 produced by firing the two-component developer 11 containing the charge control agent contains potassium. Therefore, potassium ions can be eluted from the water purification agent 20 into water, and nutrients can be supplied to the algae 16 and phytoplankton. Accordingly, the water quality can be improved by photosynthesis implemented by the algae 16 and phytoplankton.

As the wax dispersant, a wax dispersant commonly used in the relevant technical field can be used. Moreover, as the grinding aid, a grinding aid commonly used in the relevant technical field can be used.

As the external additive, an external additive commonly used in the relevant technical field can be used, but at least one type of external additive containing the silica particles 4 must be used. Colloidal silica, fumed silica, or the like synthesized by the sol-gel method can be used. The silica particles 4 may be surface-treated with a silicone resin, a silane coupling agent, or the like. The average particle size D50 of the primary particles of the silica particles 4 is not particularly limited, but is preferably 200 nm or less. The average particle size D50 thereof is more preferably from 5 to 100 nm.

Since the silica particles 4 are heat resistant, the description of the silica particles 4 is a description of both the silica particles 4 contained in the toner and the silica particles 4 contained in the iron ion-eluting particle 5.

In the iron ion-eluting particle 5 contained in the water purification agent 20, the silica particles 4 are present in the carbon layer 3 or on the surface of the carbon layer 3. Because the water purification agent 20 contains the silica particles 4, harmful metal ions in water can be adsorbed on the surface of the silica particles 4, and the water quality can be improved. This adsorption of harmful metal ions is specifically thought to occur as follows. When divalent iron ions are eluted from the iron ion-eluting particles 5 into water, some of the divalent iron ions are oxidized by dissolved oxygen and become trivalent. The trivalent iron becomes iron hydroxide and adsorbs heavy metal ions. The iron hydroxide that has adsorbed heavy metal approaches the silica particles 4 due to the zeta potential and is adsorbed thereto. The silica particles 4 can also adsorb harmful metals using the silanol groups (Si—OH) on the surface.

In addition, by setting the average particle size D50 of the primary particles of the silica particles 4 to be equal to or less than 200 nm, detachment of the silica particles 4 from the iron ion-eluting particles 5 can be suppressed. In addition, the specific surface area of the silica particles 4 can be increased, and a large amount of harmful metals can be adsorbed.

The carbon layer 3 may have a carbon material produced by carbonization of an organic component (a resin contained in the resin layer 13, the toner, or the like) contained in the two-component developer 11 and a carbon material (a carbon material contained in the resin layer 13, the toner, or the like, for example, carbon black) contained in the two-component developer 11. In addition, in a case in which the iron ion-eluting particles 5 are produced by mixing the two-component developer 11 with a carbon material or an organic component and firing the mixture, the carbon layer 3 can contain a carbon material added before firing or a carbon material generated by carbonization of an organic component added before firing. The carbon layer 3 may be a porous layer or a dense layer.

The carbon layer 3 is adhered or affixed to the surface of the magnetic particle 2. Moreover, the carbon layer 3 has a shape extending along the surface of the magnetic particle 2. Thereby, detachment of the carbon material contained in the carbon layer 3 from the iron ion-eluting particle 5 when the water purification agent 20 is immersed in water can be suppressed. As a result, divalent iron ions can be eluted from the water purification agent 20 into the water for a long period of time. In addition, the surface area of contact between the magnetic particle 2 and the carbon layer 3 can be increased, and the electrons of the magnetic particle 2 can easily move to the carbon layer 3.

The coverage rate of the carbon layer 3 covering the magnetic particle 2 is preferably from 80% to 99%. Such a coverage rate facilitates the movement of electrons of the magnetic particle 2 into the carbon layer 3, and the amount of divalent iron ions eluted from the iron ion-eluting particles 5 into water can be increased.

Moreover, the proportion of the carbon layer 3 in the iron ion-eluting particle 5 is preferably from 1.0 wt. % to 10 wt. %. Such a proportion of the carbon layer 3 facilitates the movement of electrons of the magnetic particle 2 into the carbon layer 3, and the amount of divalent iron ions eluted from the iron ion-eluting particles 5 into water can be increased. In addition, adsorption of the eluted divalent iron ions onto the carbon layer 3 can be suppressed.

### Preparation of Water Purification Agent

Samples of Examples 1 to 32 and samples of Comparative Examples 1 to 4described in Table 1 were prepared. Specifically, the samples were prepared as follows.

TABLE 1

| | | | | | Carbon | | | | |
|---|---|---|---|---|---|---|---|---|---|
| | Particle | | | | Layer | | Silica | | |
| | Size | | Surface | Ascorbic | Coverage | Carbon | Particle | | |
| | (D50) | (D90 − | Area | Acid | Rate | Content | Size | | |
| | (μm) | D10)/D50 | (m²/g) | (wt. %) | (%) | (%) | (nm) | Circularity | Firing |
| Example 1 | 40 | 1.5 | 10 | 3 | 90.0 | 5 | 7 | 0.97 | yes |
| Example 2 | 19 | 1.5 | 20 | 3 | 90.0 | 7 | 7 | 0.98 | yes |
| Example 3 | 20 | 1.5 | 20 | 3 | 90.0 | 7 | 7 | 0.98 | yes |
| Example 4 | 100 | 1.5 | 5 | 3 | 85.0 | 4 | 7 | 0.95 | yes |
| Example 5 | 105 | 1.5 | 5 | 3 | 81.0 | 3 | 7 | 0.95 | yes |
| Example 6 | 40 | 0.4 | 16 | 3 | 90.0 | 5 | 7 | 0.97 | yes |
| Example 7 | 40 | 0.5 | 13 | 3 | 90.0 | 5 | 7 | 0.97 | yes |
| Example 8 | 40 | 1.9 | 8 | 3 | 90.0 | 5 | 7 | 0.97 | yes |
| Example 9 | 40 | 2.2 | 7 | 3 | 90.0 | 5 | 7 | 0.97 | yes |
| Example 10 | 90 | 1.5 | 0.3 | 3 | 90.0 | 2 | 7 | 0.97 | yes |
| Example 11 | 90 | 1.5 | 0.5 | 3 | 90.0 | 2 | 7 | 0.97 | yes |
| Example 12 | 20 | 1.5 | 50 | 3 | 85.0 | 8 | 7 | 0.97 | yes |
| Example 13 | 20 | 1.5 | 52 | 3 | 85.0 | 8 | 7 | 0.97 | yes |
| Example 14 | 40 | 1.5 | 10 | 0 | 90.0 | 5 | 7 | 0.97 | yes |
| Example 15 | 40 | 1.5 | 10 | 0.5 | 90.0 | 5 | 7 | 0.97 | yes |
| Example 16 | 40 | 1.5 | 10 | 1 | 90.0 | 5 | 7 | 0.97 | yes |
| Example 17 | 40 | 1.5 | 10 | 5 | 90.0 | 5 | 7 | 0.97 | yes |
| Example 18 | 40 | 1.5 | 10 | 8 | 90.0 | 5 | 7 | 0.97 | yes |
| Example 19 | 45 | 1.5 | 3 | 3 | 99.5 | 9.5 | 7 | 0.97 | yes |
| Example 20 | 43 | 1.5 | 4 | 3 | 99.0 | 9 | 7 | 0.97 | yes |
| Example 21 | 35 | 1.5 | 40 | 3 | 80.0 | 2 | 7 | 0.97 | yes |
| Example 22 | 30 | 1.5 | 46 | 3 | 79.0 | 1.5 | 7 | 0.97 | yes |
| Example 23 | 40 | 1.5 | 10 | 3 | 81.0 | 0.8 | 7 | 0.97 | yes |
| Example 24 | 40 | 1.5 | 10 | 3 | 83.0 | 1 | 7 | 0.97 | yes |
| Example 25 | 40 | 1.5 | 10 | 3 | 96.0 | 10 | 7 | 0.97 | yes |
| Example 26 | 40 | 1.5 | 10 | 3 | 99.0 | 11 | 7 | 0.97 | yes |
| Example 27 | 40 | 1.5 | 10 | 3 | 90.0 | 5 | 30 | 0.97 | yes |
| Example 28 | 40 | 1.5 | 10 | 3 | 90.0 | 5 | 100 | 0.97 | yes |
| Example 29 | 40 | 1.5 | 10 | 3 | 90.0 | 5 | 190 | 0.97 | yes |
| Example 30 | 40 | 1.5 | 10 | 3 | 90.0 | 5 | 210 | 0.97 | yes |
| Example 31 | 40 | 1.5 | 10 | 3 | 90.0 | 5 | 10 | 0.83 | yes |
| Example 32 | 40 | 1.5 | 10 | 3 | 90.0 | 5 | 10 | 0.86 | yes |
| Comparative | 40 | 1.5 | 10 | 3 | — | 10 | — | — | no |
| Example 1 | | | | | | | | | |
| Comparative | 40 | 1.5 | 10 | 3 | — | — | 7 | — | no |
| Example 2 | | | | | | | | | |
| Comparative | 40 | 1.7 | 10 | 3 | — | 0 | — | — | yes |
| Example 3 | | | | | | | | | |
| Comparative | 60 | 1.9 | 8 | 3 | 60.0 | 5 | — | — | no |
| Example 4 | | | | | | | | | |

### Example 1

### Carrier Preparation

Carbon black (Ketjen Black EC, available from Lion Specialty Chemicals Co., Ltd.) was added at an amount of 5.0 wt. % to a silicone resin (KR-255, available from Shin-Etsu Chemical Co., Ltd.) serving as a coating resin, and the mixture was dissolved or dispersed in toluene to obtain a dispersion. The obtained dispersion was coated onto a carrier core material (MnMg ferrite, average particle size: 40 μm) using a fluidized bed type coating apparatus, the applied coating resin was cured by heating at 250° C. for 2 hours, and a carrier was thereby obtained.

### Toner Preparation

Binder resin: 89 mass % of a polyester resin
Colorant: 8 mass % of carbon black (product name: MA-77, available from Mitsubishi Chemical Corporation)
Release agent: 2 mass % of paraffin wax (melting point: 90° C., product name: Fischer-Tropsch Wax FNP0090, available from Nippon Seiro Co., Ltd.)

The above-described raw materials of the toner particles (toner cores) were premixed for 5 minutes at a rotational speed of 1500 rpm using a high-performance fluid-type mixer (Henschel mixer, total capacity: 20 L, model: FM20C, available from Mitsui Mining Co., Ltd. (now Nippon Coke & Engineering Co., Ltd.)).

The obtained mixture was melt-kneaded using a twin-screw extruder (model: PCM-30, available from Ikegai Corp.) under conditions including a cylinder temperature setting of 100° C., a barrel rotational speed of 250 rpm, and a raw material feeding rate of 10 kg/hour, and a melt-kneaded product was thereby obtained.

The melt-kneaded product that was obtained was cooled using a cooling belt and solidified, after which the solidified product was finely pulverized using a fluidized bed-type counter current jet mill (model: Counter Jet Mill AFG, available from Hosokawa Micron Corporation) and then classified (subjected to particle size adjustment) using a rotary (centrifugal airflow) classifier (model: TSP Separator, available from Hosokawa Micron Corporation), and thereby toner particles (toner cores) having a volume average particle size of from 5.0 μm to 7.0 μm were obtained.

As external additives, 10 g of commercially available fine silica particles (trade name: R976s, available from Nippon Aerosil Co., Ltd., average particle size: 7 nm) and 3 g of silica-doped strontium titanate (a fine powder of a composition containing strontium titanate and silica, the surface of which was hydrophobized with a silane compound, average primary particle size: 20 μm) were added to 1000 g of the obtained toner particles and then mixed for 3 minutes at a rotational speed of 3500 rpm using a high-performance fluid-type mixer (Henschel mixer, total capacity: 20 L, model: FM20C, available from Mitsui Mining Co., Ltd. (now Nippon Coke & Engineering Co., Ltd.)), and 1 kg of a toner was thereby obtained.

### Preparation of Used Developer

The toner obtained by the above production method and a carrier were weighed so as to have a toner concentration of 7.0% (toner/carrier= 1/13.3), and the mixture was stirred and mixed for 20 minutes with a V-type mixer (model: V-5, available from Tokuju Corporation), and a two-component developer was thereby obtained. A developing unit of a commercially available copier was filled with the two-component developer, and 100000 sheets of A4 size recording paper were printed with a printing percentage of 5%, after which the two-component developer was removed from the developing tank, and a used developer (life developer) was thereby prepared.

### Preparation of Water Purification Agent

The used developer that was prepared and waste toner (added if the carbon content was small) were mixed (adjusted so that the carbon content was 5%), and the mixture was inserted into a crucible. The crucible was placed in an electric furnace (small electric furnace, Hicera Kiln SH-OMT-BS2S) inserted into a glove box purged with nitrogen gas, heated to 700° C. at a heating rate of 10° C./min, maintained at that temperature for 1 hour, and then cooled and removed, and thereby a sample of Example 1 was prepared. The prepared sample was in a powder form.

### Example 2

A water purification agent was prepared in the same manner as in Example 1 with the exception that a carrier core material having an average particle size of 19 μm was used and the carbon content was adjusted to 7%.

### Example 3

A water purification agent was prepared in the same manner as in Example 1 with the exception that a carrier core material having an average particle size of 20 μm was used and the carbon content was adjusted to 7%.

### Example 4

A water purification agent was prepared in the same manner as in Example 1 with the exception that a carrier core material having an average particle size of 100 μm was used and the carbon content was adjusted to 4%.

### Example 5

A water purification agent was prepared in the same manner as in Example 1 with the exception that a carrier core material having an average particle size of 105 μm was used and the carbon content was adjusted to 3%.

### Example 6

A water purification agent was prepared in the same manner as in Example 1 with the exception that a carrier core material having a ratio (D90−D10)/D50 of 0.4 was used.

### Example 7

A water purification agent was prepared in the same manner as in Example 1 with the exception that a carrier core material having a ratio of (D90−D10)/D50 of 0.5 was used.

### Example 8

A water purification agent was prepared in the same manner as in Example 1 with the exception that a carrier core material having a ratio of (D90−D10)/D50 of 1.9 was used.

### Example 9

A water purification agent was prepared in the same manner as in Example 1 with the exception that a carrier core material having a ratio of (D90−D10)/D50 of 2.2 was used.

### Example 10

A water purification agent was prepared in the same manner as in Example 1 with the exception that a carrier core material having an average particle size of 90 μm was used and the carbon content was adjusted to 2%.

### Example 11

A water purification agent was prepared in the same manner as in Example 1 with the exception that a carrier core material having an average particle size of 90 μm was used and the carbon content was adjusted to 2%.

### Example 12

A water purification agent was prepared in the same manner as in Example 1 with the exception that a carrier core material having an average particle size of 20 μm was used and the carbon content was adjusted to 8%.

### Example 13

A water purification agent was prepared in the same manner as in Example 1 with the exception that a carrier core material having an average particle size of 20 μm was used and the carbon content was adjusted to 8%.

### Example 14

The same water purification agent as that of Example 1 was used. However, in Example 14, ascorbic acid was not added in the measurement of the divalent iron ion concentration.

### Example 15

The same water purification agent as that of Example 1 was used. However, in Example 15, 0.5 wt. % of ascorbic acid was added in the measurement of the divalent iron ion concentration.

### Example 16

The same water purification agent as that of Example 1 was used. However, in Example 16, 1.0 wt. % of ascorbic acid was added in the measurement of the divalent iron ion concentration.

### Example 17

The same water purification agent as that of Example 1 was used. However, in Example 17, 5.0 wt. % of ascorbic acid was added in the measurement of the divalent iron ion concentration.

### Example 18

The same water purification agent as that of Example 1 was used. However, in Example 18, 8.0 wt. % of ascorbic acid was added in the measurement of the divalent iron ion concentration.

### Example 19

A water purification agent was prepared in the same manner as in Example 1 with the exception that a carrier core material having an average particle size of 45 μm was used and the carbon content was adjusted to 9.5%.

### Example 20

A water purification agent was prepared in the same manner as in Example 1 with the exception that a carrier core material having an average particle size of 43 μm was used and the carbon content was adjusted to 9.0%.

### Example 21

A water purification agent was prepared in the same manner as in Example 1 with the exception that a carrier core material having an average particle size of 35 μm was used and the carbon content was adjusted to 2.0%.

### Example 22

A water purification agent was prepared in the same manner as in Example 1 with the exception that a carrier core material having an average particle size of 30 μm was used and the carbon content was adjusted to 1.5%.

### Example 23

A water purification agent was prepared in the same manner as in Example 1 with the exception that the carbon content was adjusted to 0.8%.

### Example 24

A water purification agent was prepared in the same manner as in Example 1 with the exception that the carbon content was adjusted to 1.0%.

### Example 25

A water purification agent was prepared in the same manner as in Example 1 with the exception that the carbon content was adjusted to 10.0%.

### Example 26

A water purification agent was prepared in the same manner as in Example 1 with the exception that the carbon content was adjusted to 11.0%.

### Example 27

A water purification agent was prepared in the same manner as in Example 1 with the exception that fine silica particles having an average particle size of 30 nm were used.

### Example 28

A water purification agent was prepared in the same manner as in Example 1 with the exception that fine silica particles having an average particle size of 100 nm were used.

### Example 29

A water purification agent was prepared in the same manner as in Example 1 with the exception that fine silica particles having an average particle size of 190 nm were used.

### Example 30

A water purification agent was prepared in the same manner as in Example 1 with the exception that fine silica particles having an average particle size of 210 nm were used.

### Example 31

A water purification agent was prepared in the same manner as in Example 1 with the exception that fine silica particles having an average particle size of 10 nm were used.

### Example 32

A water purification agent was prepared in the same manner as in Example 1 with the exception that fine silica particles having an average particle size of 10 nm were used.

### Comparative Example 1

The carrier prepared in Example 1 and carbon black were mixed so as to have the composition described in Table 1, and thereby a sample of Comparative Example 1 was prepared. Firing was not implemented.

### Comparative Example 2

The used developer prepared in Example 1 (without firing) was used.

### Comparative Example 3

The carrier core material used to prepare the carrier of Example 1 was placed in a crucible. The crucible was placed in an electric furnace (small electric furnace, Hicera Kiln SH-OMT-BS2S) inserted into a glove box purged with nitrogen gas, heated to 700° C. at a heating rate of 10° C./min, maintained at that temperature for 1 hour, and then cooled and removed, and thereby a sample of Comparative Example 3 was prepared. The prepared sample was in a powder form.

### Comparative Example 4

Iron powder removed from a disposable hand warmer was mixed with the waste toner prepared in Example 1 (the mixture was adjusted to have the carbon content indicated in Table 1), and the mixture was inserted into a crucible. The crucible was placed in an electric furnace (small electric furnace, Hicera Kiln SH-OMT-BS2S) inserted into a glove box purged with nitrogen gas, heated to 700° C. at a heating rate of 10° C./min, maintained at that temperature for 1 hour, and then cooled and removed, and thereby a sample of Comparative Example 4 was prepared. The prepared sample was in a powder form.

### Measurement of Particle Size Distribution

The average particle size D50 and the ratio (D90−D10)/D50 of each of the samples of Examples 1 to 32 and Comparative Examples 1 to 4 were measured using a Microtrac particle size analyzer (available from Nikkiso Co., Ltd.). The measurement results are presented in Table 1.

### Measurement of Specific Surface Area

The specific surface area of each of the samples of Examples 1 to 32 and Comparative Examples 1 to 4 was measured using an adsorption amount measuring device (BELSORP MINI II) available from MicrotracBEL Corp. The measurement results are presented in Table 1.

### SEM Observations

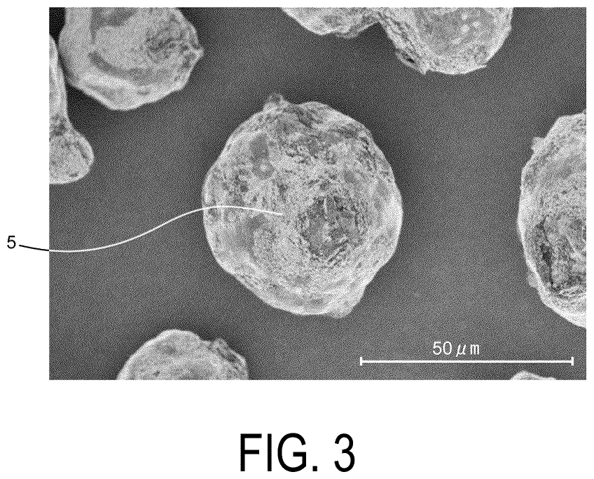

The samples of Examples 1 to 32 and Comparative Example 4 were observed with a scanning electron microscope (SEM). In particular, each sample was observed with an electron beam having an accelerating voltage of 2.0 kV using a scanning electron microscope (SEM) without vapor-depositing a conductive agent such as gold on the surface of the sample. FIG. 3 is an SEM image of a sample. In addition, the carbon layer coverage rate (%) was calculated from the SEM image of each sample of Examples 1 to 32 and Comparative Example 4. The magnetic particles (MnMg ferrite) in the carrier were observed as white, and therefore a ratio of the region of portions other than the white magnetic particles to the total surface area of the carrier was calculated. This ratio was calculated for 100 particles of the water purification agent, and the average value of the obtained values was considered to be the magnetic particle exposure rate. From the magnetic particle exposure rate calculated for each sample, the coverage rate (carbon layer coverage rate) at which the carbon layer covered the magnetic particles was calculated using the following equation: carbon layer coverage rate=100-magnetic particle exposure rate. The carbon layer coverage rate of each sample is described in Table 1.

Further, the circularity was calculated from the SEM image of each of the samples of Examples 1 to 32. The circularity is an average value of the circularity obtained from the images of 50 particles, and is calculated from 4π×(area)/(perimeter²). When the circularity is 1, the shape is a perfect circle. The circularity of the particles was calculated using ImageJ software available from the National Institutes of Health of the United States. The circularity calculated for each sample is indicated in Table 1.

The particle size (D50) indicated in Table 1 for the silica particles is the particle size of the silica particles used in the preparation of the toner.

### Measurement of Silica Adhesion Ratio

The silica adhesion ratio X of each sample of Examples 1 to 32 was measured. Specifically, 1 g of the sample was added to 20 mL of a 0.2 mass % aqueous solution of polyoxyethylene(10) octylphenyl ether (Triton X-100), the mixture was stirred for 5 minutes and then suction-filtered through a membrane filter having a pore size of 1 μm, and the obtained residue was vacuum-dried. Subsequently, the dried residue was analyzed using an X-ray fluorescence analyzer (model: ZSX Primus IV, available from Rigaku Corporation), and the average peak intensity Xa of the element Si was measured. In addition, the average peak intensity Xp of Si was measured in the same manner as with the sample prior to treatment with the aqueous solution, and the silica adhesion ratio X was determined from the equation X=Xa/Xp. The calculated silica adhesion ratio is described in Table 2.

### Measurement of Carbon Content

The samples of Examples 1 to 32 and Comparative Examples 1, 3, and 4 were subjected to thermogravimetric analysis (TGA) to measure the carbon content of each sample. Specifically, the sample was heated from 40° C. to 600° C. at a temperature increase rate of 20° C./min in a nitrogen atmosphere, and then maintained at 600° C. for 5 minutes. Here, the organic matter other than carbon was decomposed. Subsequently, the temperature was lowered to 400° C. at a cooling rate of 20° C./min, the atmosphere was changed from nitrogen to air, and this state was maintained for 5 minutes, after which the temperature was raised to 800° C. at a temperature increase rate of 20° C./min and then maintained at 800° C. for 30 minutes. The weight reduction rate after the nitrogen atmosphere was changed to the air atmosphere was defined as the carbon content. The carbon content calculated for each sample is presented in Table 1.

### Measurement of Divalent Iron Ion Concentration

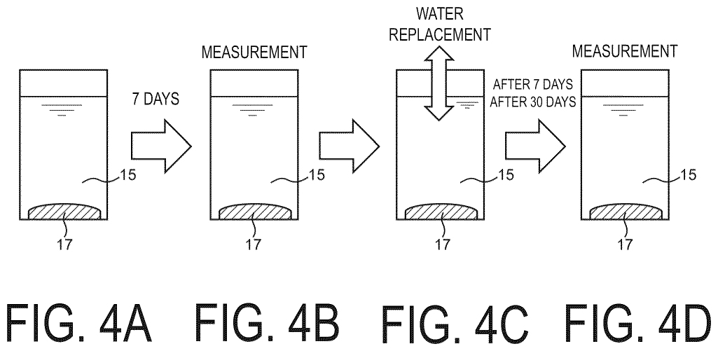

The concentration of divalent iron ions eluted from each sample of Examples 1 to 32 and Comparative Examples 1, 3, and 4 was measured. FIG. 4 is an explanatory diagram of this measurement method. Specifically, a prepared sample 17, distilled water (water 15) of an amount of 20 times the weight of the sample, and ascorbic acid (not inserted in Example 14) of the amount described in Table 1 (the amount being the wt. % with respect to the prepared sample) were inserted into a glass sample bottle (100 g of distilled water in a case of 5 g of the sample) (FIG. 4A), and the supernatant after 7 days was analyzed using the Packtest (available from Kyoritsu Chemical-Check Lab., Corp.) to measure the concentration of divalent iron ions (FIG. 4B). Subsequently, the sample was collected by suction filtration through a membrane filter having a pore size of 1 μm. The collected sample and distilled water of an amount of 20 times the weight of the sample were then placed in the glass bottle. In this manner, the water was replaced (FIG. 4C). After the water was replaced, the supernatant after 7 days and the supernatant after 30 days were analyzed using the Packtest (available from Kyoritsu Chemical-Check Lab., Corp.), and thereby the concentration of divalent iron ions was measured (FIG. 4D).

The measurement results are presented in Table 2. In Examples 1 to 32, the concentration of divalent iron ions 30 days after the replacement of water was 1 ppm or greater, whereas in Comparative Examples 1, 3, and 4, the concentration of divalent iron ions 30 days after the replacement of water was 0.5 ppm or less. From these results, it was found that when a sample prepared by firing a used two-component developer is used as a water purification agent, divalent iron ions can be continuously eluted into water.

TABLE 2

| | | Fe²⁺ | Fe²⁺ | |
|---|---|---|---|---|
| | Fe²⁺ | Concen- | Concen- | |
| | Concen- | tration | tration | |
| | tration | (ppm) 7 Days | (ppm) 30 Days | Silica |
| | (ppm) After | After Water | After Water | Adhesion |
| | 7 Days | Replacement | Replacement | Ratio (%) |
| Example 1 | 10 | 10 | >10 | 85 |
| Example 2 | 3 | 3 | 5 | 85 |
| Example 3 | 5 | 5 | >10 | 85 |
| Example 4 | 5 | 5 | >10 | 85 |
| Example 5 | 5 | 3 | 3 | 85 |
| Example 6 | 1 | 3 | 5 | 85 |
| Example 7 | 5 | 5 | >10 | 85 |
| Example 8 | 5 | 5 | >10 | 85 |
| Example 9 | 3 | 3 | 3 | 85 |
| Example 10 | 1 | 3 | 5 | 85 |
| Example 11 | 3 | 5 | 10 | 85 |
| Example 12 | 5 | 5 | >10 | 85 |
| Example 13 | 3 | 3 | 5 | 85 |
| Example 14 | 1 | 3 | 5 | 85 |
| Example 15 | 3 | 3 | 5 | 85 |
| Example 16 | 5 | 10 | >10 | 85 |
| Example 17 | 10 | 10 | >10 | 85 |
| Example 18 | 10 | 3 | 1 | 85 |
| Example 19 | 0.5 | 0.5 | 1 | 85 |
| Example 20 | 5 | 5 | 10 | 85 |
| Example 21 | 5 | 5 | >10 | 85 |
| Example 22 | 3 | 3 | 5 | 85 |
| Example 23 | 0.5 | 3 | 3 | 85 |
| Example 24 | 3 | 5 | 10 | 85 |
| Example 25 | 10 | 10 | >10 | 85 |
| Example 26 | 1 | 1 | 1 | 85 |
| Example 27 | 10 | 10 | >10 | 75 |
| Example 28 | 5 | 10 | >10 | 60 |
| Example 29 | 5 | 5 | 10 | 50 |
| Example 30 | 3 | 5 | 10 | 30 |
| Example 31 | 3 | 3 | 5 | 85 |
| Example 32 | 3 | 5 | 10 | 85 |
| Comparative | 0.1 | <0.05 | <0.05 | — |
| Example 1 | | | | |
| Comparative | <0.05 | <0.05 | <0.05 | — |
| Example 3 | | | | |
| Comparative | 1 | 0.2 | 0.5 | — |
| Example 4 | | | | |

1. A water purification agent comprising iron ion-eluting particles, and each iron ion-eluting particle comprising:
a magnetic particle containing iron;
a carbon layer adhered to a surface of the magnetic particle; and
silica particles adhered to the surface of the magnetic particle or the carbon layer.

2. The water purification agent according to claim 1, wherein the carbon layer is affixed to the surface of the magnetic particle.

3. The water purification agent according to claim 1, wherein the iron ion-eluting particles are fired bodies.

4. The water purification agent according to claim 1, wherein primary particles of the silica particles have an average particle size D50 of equal to or less than 200 nm.

5. The water purification agent according to claim 1, wherein the iron ion-eluting particles have an average particle size D50 of from 20 μm to 100 μm.

6. The water purification agent according to claim 1, wherein the plurality of iron ion-eluting particles contained in the water purification agent have a particle size distribution such that (D90−D10)/D50 is from 0.5 to 2.0.

7. The water purification agent according to claim 1, wherein a BET specific surface area of the plurality of iron ion-eluting particles contained in the water purification agent is from 0.5 m²/g to 50 m²/g.

8. The water purification agent according to claim 1, wherein the iron ion-eluting particles comprise at least one of manganese, magnesium, and potassium.

9. The water purification agent according to claim 1, further comprising ascorbic acid.

10. The water purification agent according to claim 1, wherein a coverage rate of the carbon layer covering the magnetic particle is from 80% to 99%.

11. The water purification agent according to claim 1, wherein a circularity of the iron ion-eluting particles is 0.85 or greater.

12. The water purification agent according to claim 1, wherein a proportion of the carbon layer in each iron ion-eluting particle is from 1.0 wt. % to 10 wt. %.

13. A method for producing a water purification agent, the method comprising a step of firing a two-component developer containing toner and carrier.at a temperature of 500° C. or higher.
